(19) United States
(12) Patent Application Publication
(10) Pub. No.: US 2016/0150714 A1
(43) Pub. Date: Jun. 2, 2016

(54) FLOATING DEBRIS CLEARING APPARATUS HAVING PARALLEL SUPPORT LINKAGE

(71) Applicant: A.I.L., Inc., North Platte, NE (US)

(72) Inventor: Marlin W. UNRUH, Madrid, NE (US)

(21) Appl. No.: 14/954,306

(22) Filed: Nov. 30, 2015

Related U.S. Application Data
(60) Provisional application No. 62/085,753, filed on Dec. 1, 2014.

(51) Int. Cl. A01B 49/02

(52) U.S. Cl. CPC A01B 49/02

(57) ABSTRACT

A debris clearing apparatus mounted to and pushed by a planter row unit for agricultural operations is provided, and includes a base portion configured for attachment to the row unit, a disk assembly including at least one rotating trash clearing device and a mounting bracket, and the at least one trash clearing device connected to the base portion for vertical reciprocal movement by a parallelogram linkage including at least one first arm and at least one second arm, each of the first and second arms being pivotably connected at corresponding ends to the bracket and to the base portion.

### RELATED APPLICATION

This application is a Nonprovisional of, and claims 35 USC 119 priority from U.S. Ser. No. 62/085,753 filed Dec. 1, 2014.

### BACKGROUND

The present disclosure generally relates to agricultural tillage tools, and more particularly relates to an agricultural row crop debris clearing apparatus.

An increased use of various agricultural tillage techniques has produced a need for an apparatus that can be attached to existing farm equipment, such as a planter, for clearing debris, such as mulch, plant stalks, and the like, from the ground, particularly during planting of a row crop, such as corn. It is well known that the optimum emergence of corn plants is a function of the precision with which the corn seeds are planted. It is important for desired emergence that the seed be planted at a precise depth and spacing during the planting operation. Since the depth of planting of the seed is controlled by rubber wheels of a planter, the presence of corn stalks, other mulch or debris in the row line during the planting operation can change the elevation of the wheels and therefore the planter itself. As a result, the proper seed planting and/or placement depth is impaired, which usually results in poor emergence of the crop.

It is also important that the debris be cleared from the row line if herbicides are to be applied to the field during planting. It is well known that the herbicide will be less effective if it merely contacts the debris rather than the soil itself For these reasons, there has been considerable activity in the development of debris clearing apparatus that can be attached to the planter or other equipment, which moves the mulch and debris out of the path of the planter so that accurate planting can be carried out and effective use of herbicides is achieved. Suitable examples of such debris clearing apparatus are disclosed in U.S. Pat. No. 6,279,666 and U.S. Pub. No. 2012/0261149 which are incorporated by reference.

Since the development of the invention of the '666 patent, the industry has developed tillage units with spring biased, vertically movable workheads that compensate for undulations in uneven ground. While these units have reduced many of the instances of debris clearing units losing contact with the seedbed, problems still remain. For example, in some cases, vertically movable workhead units still cause gouging of the seedbed due to a mechanical under reaction or over reaction to surface undulations.

Further, the orientation of conventional row cleaners to a tool bar or planter unit causes the row cleaners to sink into the seedbed. Some units have added gauging devices to prevent this unwanted sinking action. In one example, a generally planar, toothed row clearing wheel is attached to a fluted gauging device. In operation, such devices tend to hold, collect, and accumulate field crop debris instead of moving unwanted material away from the row cleaner, and also cause the row cleaner to ride over minor undulations in the field. These systems have proven unsatisfactory. Thus, there has been a need for crop debris clearing units which remain in contact with the ground and prevent the units from sinking into the seedbed too deeply during operation.

### SUMMARY

The present disclosure is directed to a debris clearing apparatus for agricultural operations, and particularly for use in row crop applications such as planting corn or other row crops in a field where debris is usually present from a prior growing season. More specifically, a crop row clearing device is provided where a debris clearing disk assembly is suspended relative to the planter row unit by a parallel or parallelogram linkage, including pairs of upper and lower parallel link arms. Each of the upper and lower link arms may be a single or double arm. Thus, the disk assembly floats vertically relative to the planter, under the optional control of a biasing element, to better follow ground contours. The present parallel or parallelogram linkage stabilizes the relative vertical motion of the clearing disk to the planter. Also, mechanical stops in the linkage control the degree of permitted vertical movement. Another feature of the present apparatus is that the force exerted by the disk assembly against the ground is adjustable by the operator to conform to soil and/or debris volume conditions. Looser soil or fields with less debris may call for a lighter force, while packed, clay soil or fields with significant debris from the prior year may call for heavier force.

An important feature of the present device is that the unit is “pushed” by the planter. Also, the debris clearing disk features a hub-like depth band extending generally perpendicularly from a face of the disk for maintaining a desired height of the disk in the soil. Also, a double parallel linkage helps maintain a parallel relationship of the row cleaner relative to the soil despite ground elevation undulations. The linkage includes stops for controlling relative travel of the upper and lower linkage arms. Further, the stops operate in two vertical directions, in that the lower control arms are stopped from unwanted excessive upward vertical movement, and the upper control arms are stopped from unwanted excessive lower vertical movement, so that in this manner, the vertical floating movement of the linkage is controlled. Supplemental pressurized cylinders or springs are optionally connected to the linkage to lift the linkage to a travel position, or to exert a supplemental downward or upward pressure on the linkage to maintain desired positive contact between the row cleaner and the ground.

More specifically, a debris clearing apparatus mounted to and pushed by a planter row unit for agricultural operations is provided, and includes a base portion configured for attachment to the row unit, a disk assembly including at least one rotating trash clearing device and a mounting bracket, and the at least one trash clearing device connected to the base portion for vertical reciprocal movement by a parallelogram linkage including at least one first arm and at least one second arm, each of the first and second arms being pivotably connected at corresponding ends to the bracket and to the base portion.

In another embodiment, the parallel linkage includes upper and lower transverse spring rods mounted in associated apertures in the upper and lower link arms, such as generally horizontal, stepped slots. At least a pair of the upper and lower arms has a forwardmost and rearwardmost rod position. The rods in the upper link arms are adjustable relative to the rods in the lower link arms. Springs connected between the rods exert a biasing force on the linkage. By moving the rods in the upper and lower arms relative to each other, the amount of force exerted on the disk assembly is varied and a desired positive contact between the row cleaner and the ground is achieved. Thus, when the spring is generally vertical relative to the arms, there is a neutral biasing force applied. In contrast, when the rods are at their full distance displacement from each other, the springs exert their full biasing force. Depending on whether the upper or the lower rod is more forward in the assembly determines whether there is a downforce or an upforce exerted on the disk assembly. The adjustability of the biasing force facilitates adjustment of the row cleaner to particular soil conditions. More specifically, loose soil conditions favor a situation when the row cleaner exerts reduced pressure on the soil. In harder soil, and with greater trash volume, more aggressive clearing action of the clearing disk assembly is desired, which is obtained by exerting more force on the disk assembly.

In yet another embodiment, a debris clearing apparatus mounted to and pushed by a planter row unit for agricultural operations, the planter row unit having a pivoting planter linkage, the debris clearing apparatus including a base portion configured for attachment to the row unit, a disk assembly including at least one rotating trash clearing device and a mounting bracket; and the at least one trash clearing device connected to the base portion for vertical reciprocal movement by a parallelogram linkage including at least one first arm and at least one second arm, each of the first and second arms being pivotably connected at corresponding ends to the bracket and to the base portion so that the apparatus moves relative to the ground independently from the planter linkage.

### BRIEF DESCRIPTION OF THE DRAWINGS

FIG. 1 is a side elevation of a planter row unit equipped with a debris clearing apparatus, incorporating the features of the present disclosure shown on level ground;

FIG. 2 is a side elevation of the debris clearing apparatus of FIG. 1 in an upward position upon encountering a rise in the ground;

FIG. 3 is a side elevation of the debris clearing apparatus of FIG. 1 in a downward position when encountering a dip in the ground;

FIG. 4 is a front elevation of the present debris clearing apparatus;

FIG. 5 is a side elevation of the present debris clearing apparatus;

FIG. 6 is a top view of the present debris clearing apparatus;

FIG. 7 is a top perspective view of the present debris clearing apparatus;

FIG. 8 is a fragmentary side view of the present debris clearing apparatus as shown when traversing level ground;

FIG. 9 is a fragmentary side view of the present debris clearing apparatus as shown when traveling down a dip in the ground;

FIG. 10 is a fragmentary side view of the present debris clearing apparatus as shown when traveling up a rise in the terrain;

FIG. 11 is a top perspective view of an alternate embodiment of the present debris clearing apparatus;

FIG. 12 is an exploded top fragmentary perspective view of another alternate embodiment of the present debris clearing apparatus;

FIG. 13 is a front view of the apparatus of FIG. 12;

FIG. 14 is an enlarged fragmentary front view of the apparatus of FIG. 12;

FIG. 15 is a side elevation of the apparatus of FIG. 12;

FIG. 16 is an exploded perspective view of the present expander for the depth band;

FIG. 17 is a partial vertical cross-section of an assembly of the band of FIG. 16;

FIG. 18 is a fragmentary top perspective view of an alternate embodiment of the present apparatus; and

FIG. 19 is a right side elevation of the apparatus of FIG. 18.

### DETAILED DESCRIPTION

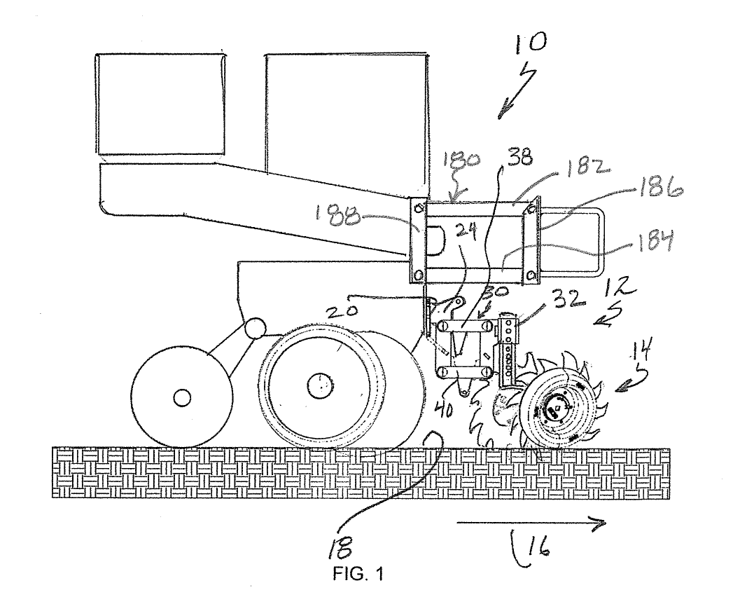

Referring now to FIGS. 1-3, an agricultural planter row unit is generally designated 10 and is of the type conventionally used for planting row crops such as corn, soybeans, and the like. An exemplary row unit 10 is described in U.S. Patent Pub. No. 2012/0261149 incorporated by reference. Included in the row unit 10 is a debris clearing apparatus, generally designated 12, having a disk assembly, generally designated 14. The debris clearing apparatus 12 advances in the direction of travel 16 when the apparatus 12 is pushed by the row unit 10. As is known in the art, the row unit 10 is pulled by a tractor (not shown).

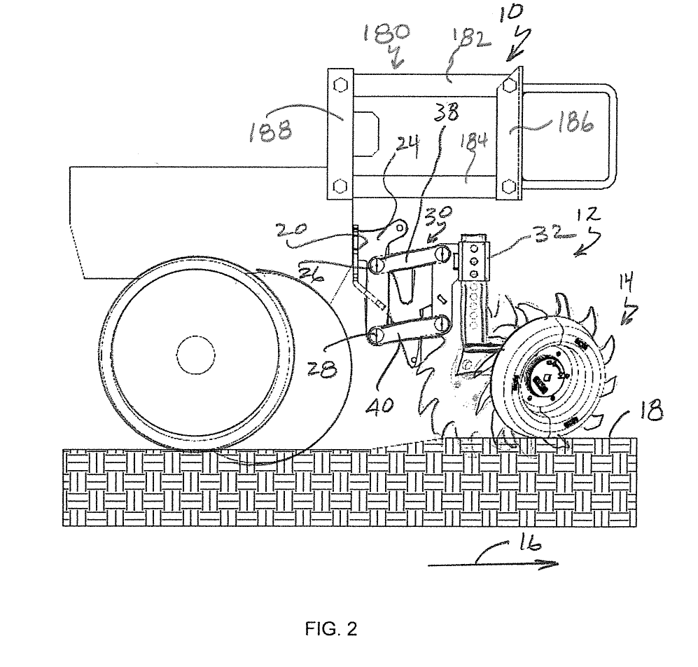

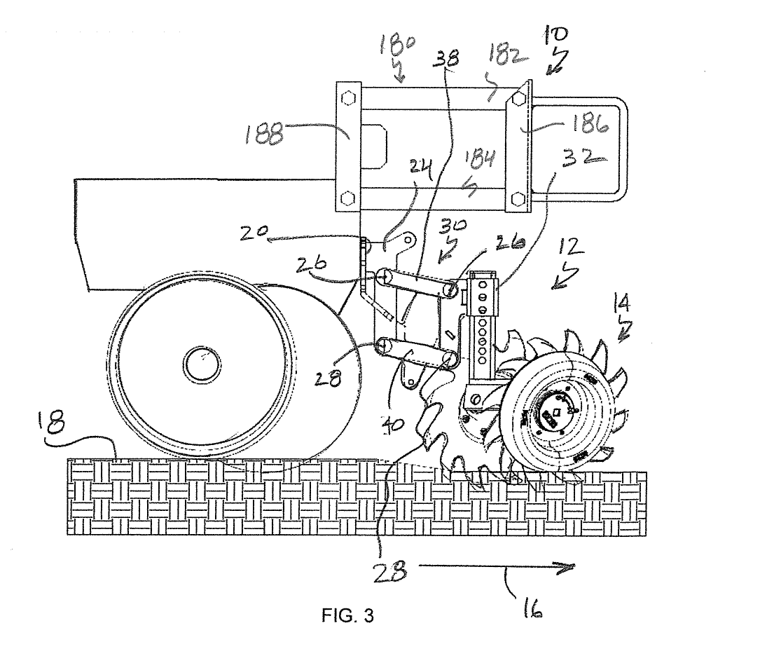

The debris clearing apparatus 12 is pivotally lowered and lifted depending on variations in the ground contour 18 to change its vertical position relative to the row unit 10. As an example, FIG. 1 illustrates the debris clearing apparatus 12 traveling on level ground, FIG. 2 illustrates the apparatus traveling up a rise in the ground, and FIG. 3 depicts the apparatus traveling in a dip in the ground.

Referring now to FIGS. 1 and 4-7, the construction of the apparatus 12 is shown in greater detail. It will be seen that the apparatus 12 is mounted to the row unit 10 using a base portion or frame plate 20, which is mountable to the row unit by at least one mounting aperture 22 accommodating bolts or other fasteners as known in the art. At least one and preferably a pair of flanges 24 extend forwardly of the base portion 20. Each flange 24 has first and second pivot mounting points 26, 28. The flanges 24 form part of a parallel or parallelogram linkage, generally designated 30, which connects the base portion 20 to the clearing disk assembly 14.

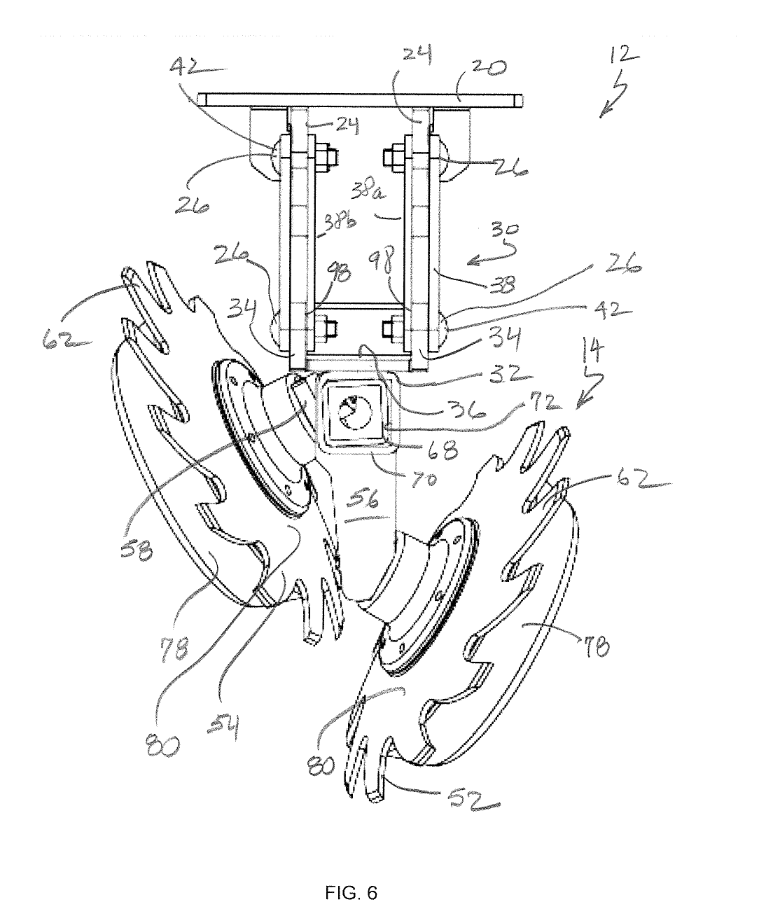

More specifically, the clearing disk assembly 14 has a mounting bracket 32 which is connected to the parallel linkage. The bracket 32 has two sides 34 and a back plate 36 which form a general “U”-shape when viewed from above (FIG. 6). Also, the mounting bracket 32 also includes the first and second pivot mounting points 26, 28. Included on the parallelogram linkage 30 is at least one first arm 38 and at least one second arm 40, and each of the first and second arms is pivotably connected at corresponding ends to the pivot mounting points 26, 28 on the flanges 24 and on the bracket 32. More specifically, each upper arm 38 is connected between each of the flanges 24 and a corresponding one of said first and second bracket sides 34. Similarly, each second arm 40 is connected between each of the flanges 24 and a corresponding one of the first and second bracket sides 34.

It will be seen that the pivot mounting points 26, 28 are vertically spaced from each other. It is further preferred in one embodiment that a pair of first arms 38 are located on each side 34 of the mounting bracket in straddling arrangement, and a pair of second arms 40 are similarly located on each side of the mounting bracket. As well known in the art, the connection points of the first and second arms 38, 40 to the flanges 24 and the bracket 32 are made by bolts 42.

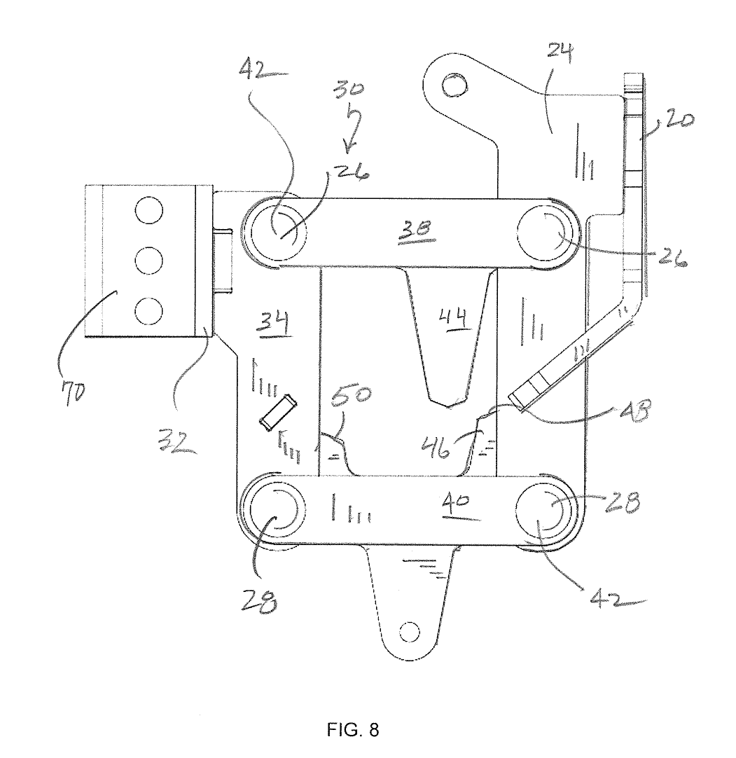

Referring now to FIGS. 8-10, another feature on the parallelogram linkage 30 is that at least one, and preferably both the first and second arms 38, 40 have mechanical stops, respectively designated 44 and 46 for limiting the degree of vertical movement of the linkage relative to the planter row unit 10. The stops 44, 46 include a depending formation on the at least one first arm 38, and a vertically extending formation on the at least one second arm 40. Vertical travel of the linkage 30 is limited when the stops 44, 46 contact each other. Also, given that the preferred construction of the linkage 30 is that there are double arms 38, 40 on each side 34 of the mounting bracket, it is contemplated that only one such arm of each set 38, 40 is equipped with the stops 44, 46. In the version depicted, the stop 44, 46 are located on innermost arms, or those closest to inside edges of the bracket 32.

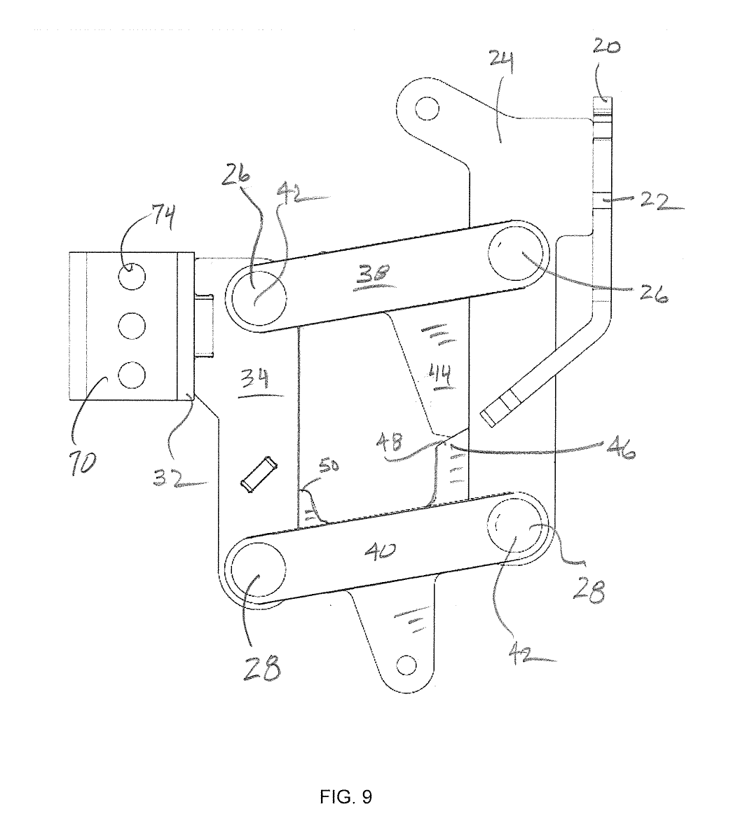

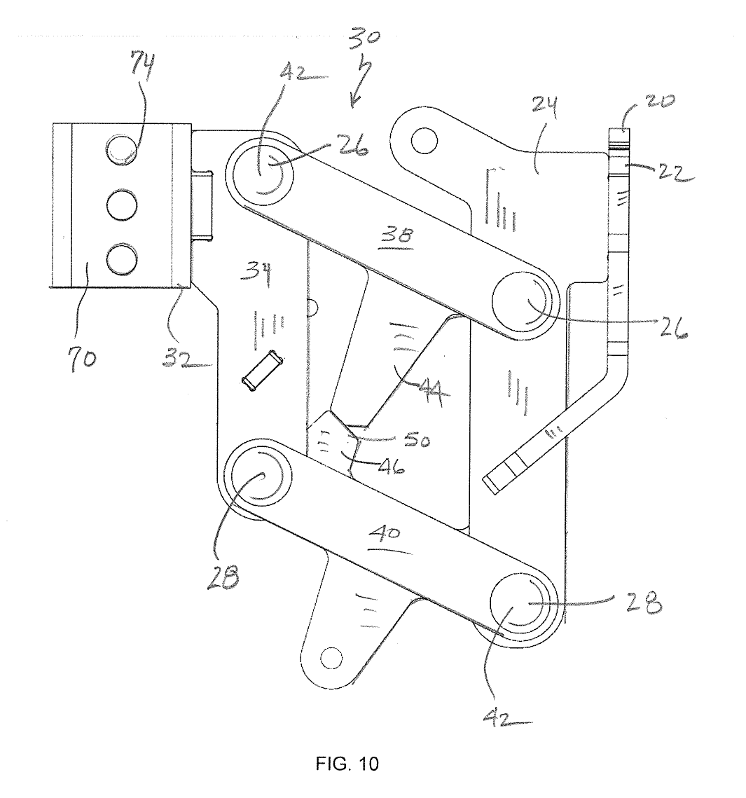

FIG. 8 depicts the linkage 30 in a level ground orientation, with the arms 38 and 40 generally parallel. The stops 44, 46 are not being engaged here. In FIG. 9, the clearing unit 12 has encountered a dip in the ground, and the linkage 30 accommodates the variation. In this case, the stops 44, 46 are in engagement for limiting the vertical movement of the linkage 30. It will be seen that the first stop 44 engages a rearward landing 48 on the second stop 46. In contrast, in FIG. 10, the linkage 30 is shown encountering a rise in the ground, and pivoting accordingly so that the first stop 44 engages a forward landing 50 on the second stop 46.

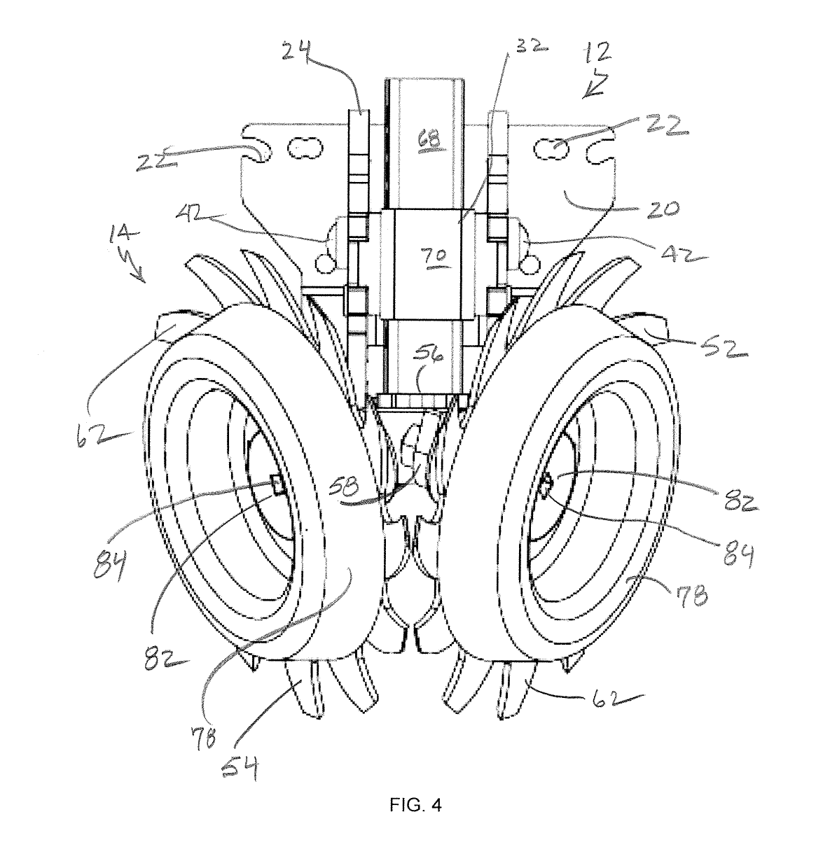

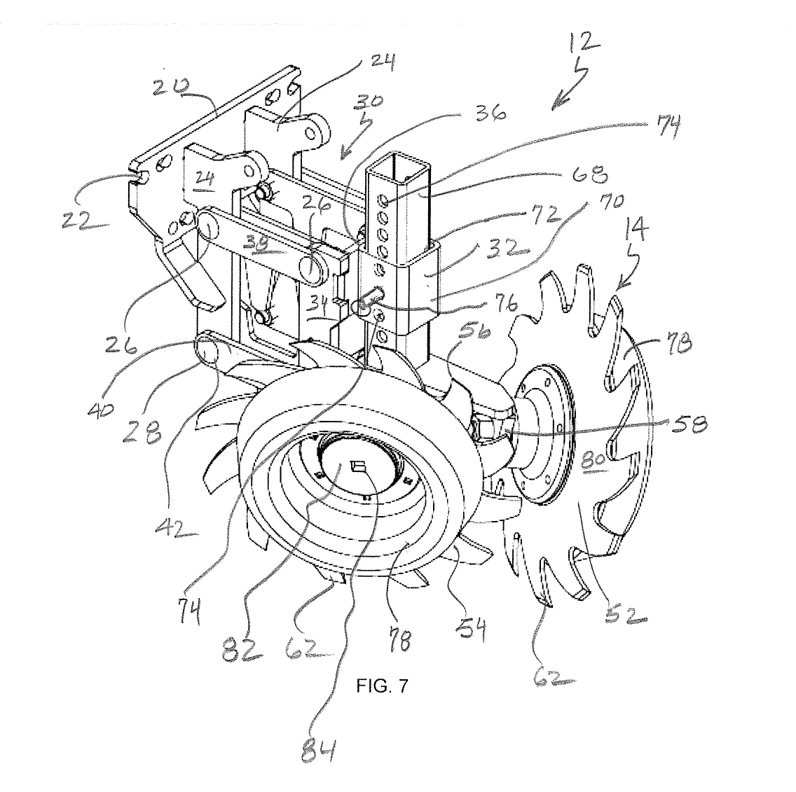

Referring again to FIGS. 4-7, the clearing disk assembly 14 includes at least one and preferably two rotating trash clearing devices, here toothed wheels or disks 52, 54. A foot structure 56 on the clearing disk assembly 14 is configured for supporting at least one disk mount 58 (FIG. 7) that in turn is constructed and arranged for receiving at least one clearing disk 52, 54. In the preferred embodiment, a pair of disks 52, 54 is provided, but a single disk is considered suitable depending on the application. For the purposes of the present application, a “disk” 52, 54 contemplates a variety of component shapes known in the art, and includes such wheels and wheel-like components having optional teeth or continuous edges, and being planar or dished (convex or concave). While other shapes are contemplated, in the preferred embodiment, the disks 52, 54 are concave facing the direction of travel 16 and have a plurality of generally radially extending teeth 62.

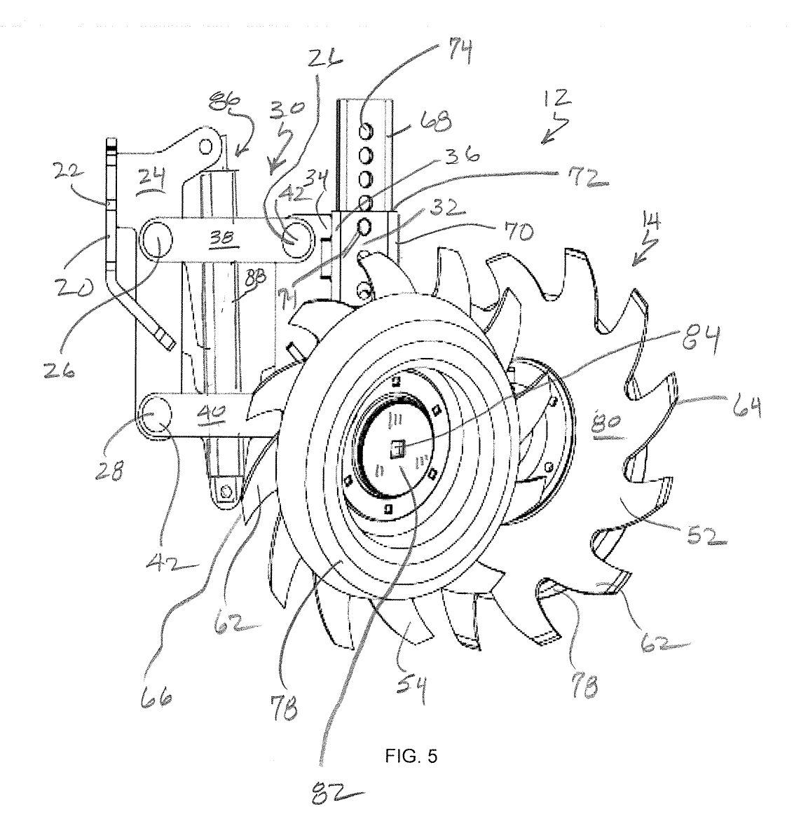

It is preferred that the disk mount 58 orient the disks 52, 54 such that the disks converge adjacent one another at a forward reach 64 of the disks (FIG. 5), a rearward reach 66 of the disks being spaced apart from one another so that general planes of the disks are angled outwardly from the forward reach to the rearward reach. In addition, the disks 52, 54 are preferably secured to the foot structure 56 to define a spacing in the direction of travel 16 of a specified distance, in the approximate range of 3 to 10 inches, as taught in U.S. Pat. No. 6,279,666 incorporated by reference. As described in the '666 patent, the above-described mounting arrangement of the disks 52, 54 is achieved by providing the foot structure 56 as a horizontal plate to which are affixed, as by welding or the like, the disk mounts 58 which are oriented at about 15° relative to the vertical such that a plane defined by outer edges of each of the disks rotatably attached to the disk mounts 58 extends outwardly farther than a lower reach.

Referring again to FIGS. 4-7, attached to the horizontal foot structure 56 is a vertically or upward projecting foot extension or stem 68 slidingly received in a receiver tube 70 on the mounting bracket 32. The foot extension 68 is configured to fit within a vertical opening 72 within the receiver tube 70. To provide relative vertical adjustability of the foot structure 56 relative to the receiver tube 70, the foot extension 68 and the receiver tube each have a plurality of vertically spaced openings 74 configured for receiving a key pin 76 (FIG. 7). The foot extension 68 is vertically adjustable relative to and within the receiver tube 70 by selectively placing the extension at a desired elevation and inserting the key pin 76 in aligned openings 74 of the foot extension and the receiver tube. It is also contemplated that the stem 68, the receiver tube 70, and the vertical opening 72 are optionally converted to a fixed mounting of the clearing disk assembly 14 relative to the linkage 30.

To further control the depth the clearing disks 52, 54 sink into the soil, the disks are preferably provided with a generally laterally extending annular depth band 78. The ring-like depth band 78 extends generally perpendicularly from a face or web 80 of the disks 52, 54. Further, the disks 52, 54 are preferably each provided with a locking hub cap 82 for providing easy access to a bearing (not shown) upon which the disks 52, 54 and the associate depth bands 78 rotates. The hub cap 82 is preferably generally centrally located relative to the depth band 78, and is secured to depth band using an over-center locking cam formation. Thus, by rotating the hub cap 82 a ¼ turn or other suitable amount, the user can readily unlock the cap and access the bearing without requiring major disassembly of the disk assembly. A user manipulates the hub cap 82 by insertion of a tool (not shown) into a keyed aperture 84 and rotation of the tool to alternate between locked and unlocked positions.

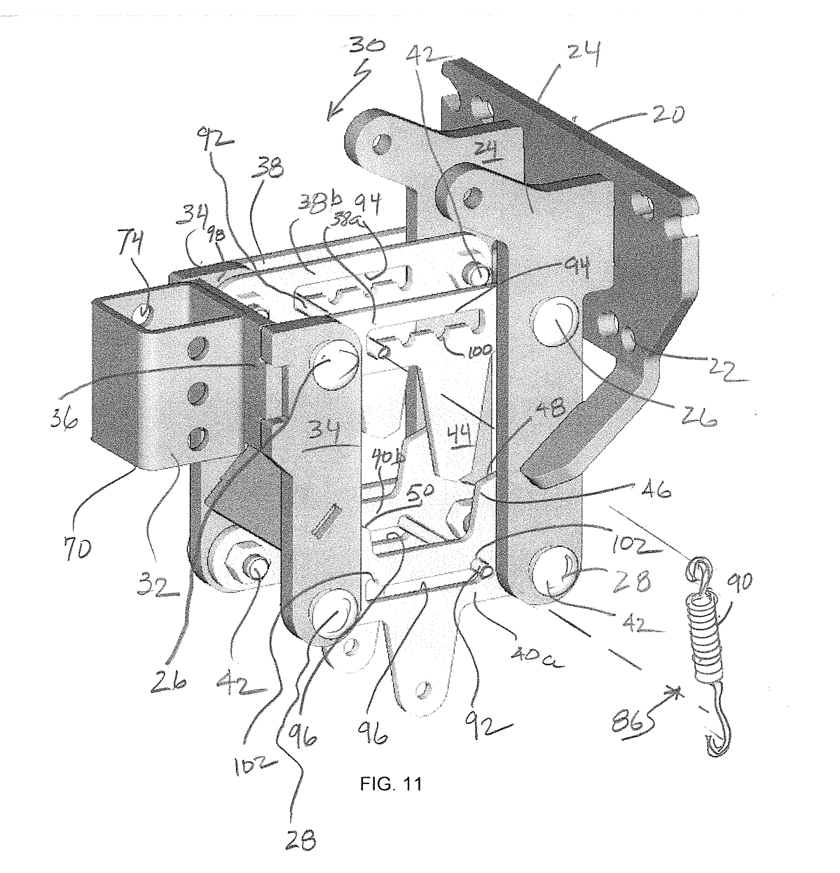

Referring now to FIGS. 5 and 11, the present debris clearing unit 12 preferably includes a biasing element, generally designated 86, associated with the parallel linkage 30 for exerting at least one of a downward and an upward biasing force on the trash clearing disk assembly as it moves through the ground. It is contemplated that the biasing element 86 is at least one of a fluid power cylinder 88 (FIG. 5), which may be a pneumatic or fluid power cylinder connected between the base portion 20 and the linkage 30, and at least one spring 90.

Referring particularly to FIG. 11, the parallel linkage 30 optionally includes upper and lower transverse spring rods 92 mounted in generally horizontal, stepped slots 94, 96 in both the first and second link arms 38, 40. The slots 94 are preferably located in the arms 38a, 38b and 40a, 40b located on inside edges 98 of the bracket sides 34. Other arrangements are contemplated, but the slots 94 are preferably located only on one of each pair of arms 38, 40. Each of the slots 94, 96 has a forwardmost and rearwardmost rod position, the rearwardmost position being closest to the planter row unit 10. The spring rods 92 are movable in the slots and are locatable in notches 100, 102 in corresponding slots 94 and 96 to be held in place in the slot. Thus, the spring rods 92 in the upper or first link arms 38 are adjustable relative to the rods in the lower link arms 40. When the spring 90 is engaged on the rods 92, a biasing force is exerted that pulls the arms 38, 40 relative to each other.

By moving the rods 92 in the upper and lower arms 38, 40 relative to each other, the spring tension is adjustable. When each spring 90 is generally vertical relative to the arms 38, 40, there is a neutral biasing force applied; and when the rods are at their full distance displacement from each other, the spring exerts a full biasing force. Further, it has been found that when the rod 92 in the slots 94 is in a forwardmost position, and the rod in the slots 96 is in a rearwardmost position (FIG. 11), a downwardly directed biasing force or downforce is exerted on the linkage 30. In contrast, when the rod 92 in the slots 94 is in a rearwardmost position and the rod in the slots 96 is in a forwardmost position, an upwardly directed biasing force or upforce is exerted on the linkage 30. This adjustability in force exerted by the linkage 30 and ultimately upon the disk assembly 14, allows the operator or user to customize the tillage apparatus to the soil and debris conditions present in the particular field. Looser soils in fields with less debris require less downforce, while relatively compacted or heavy soils with more debris require more downforce. As upforce increases, the disk assembly 14 applies a “lighter footprint” in the soil.

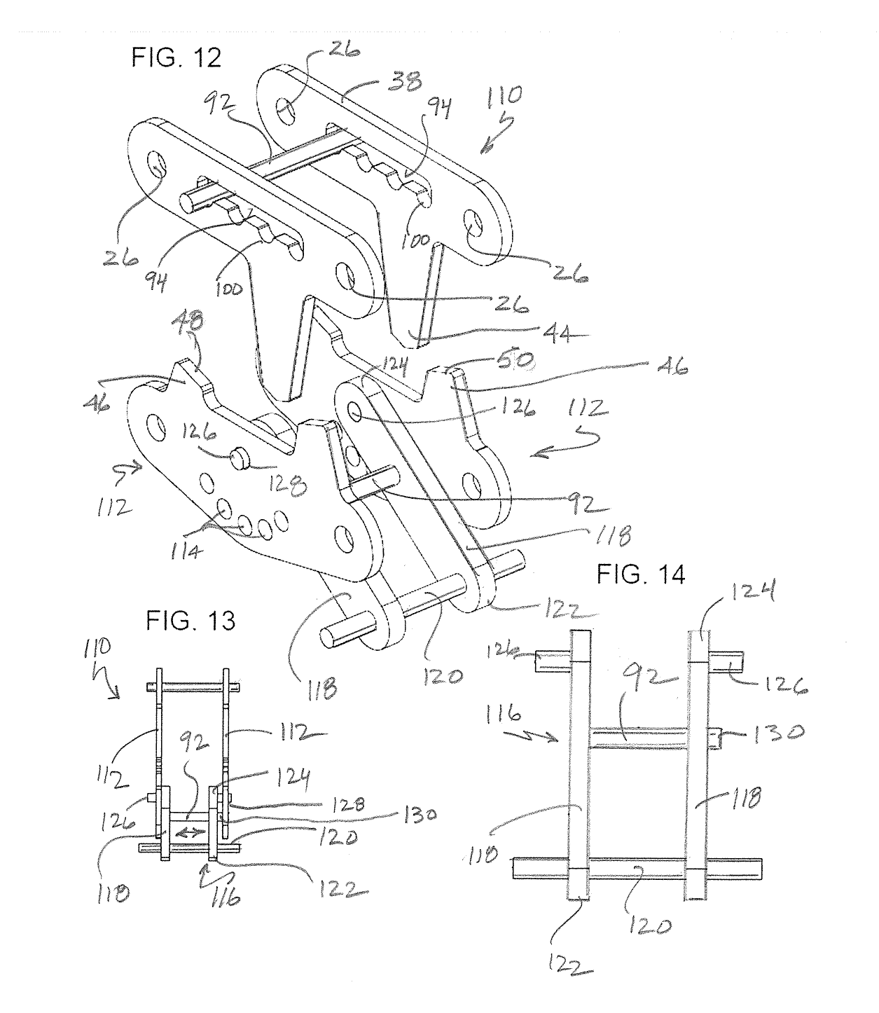

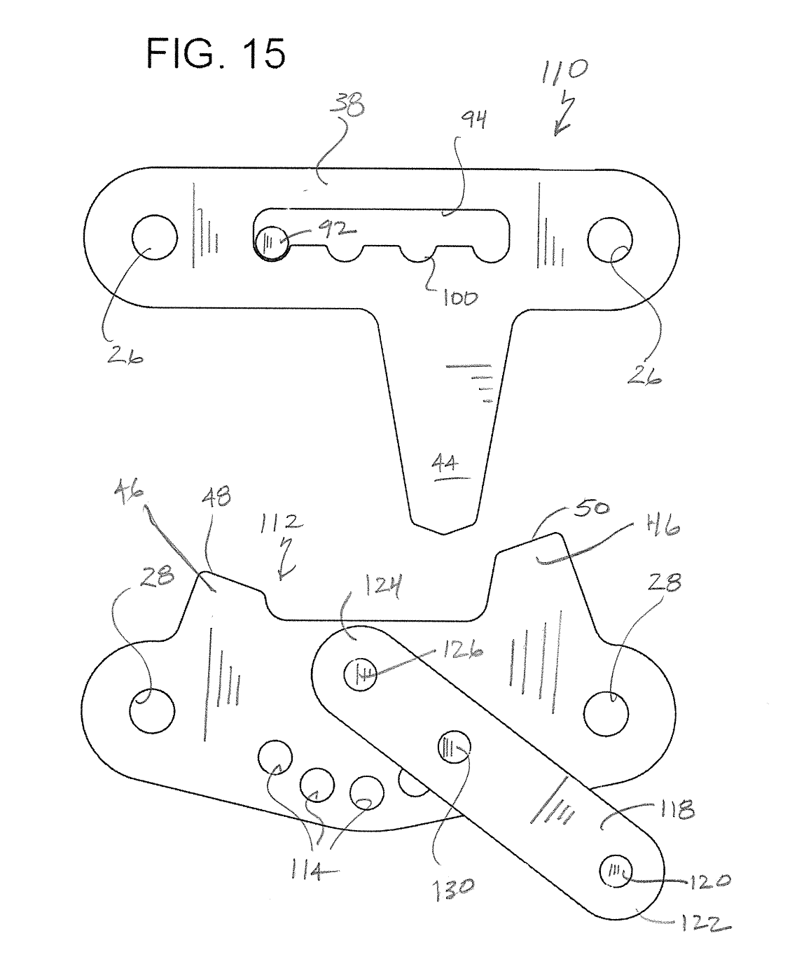

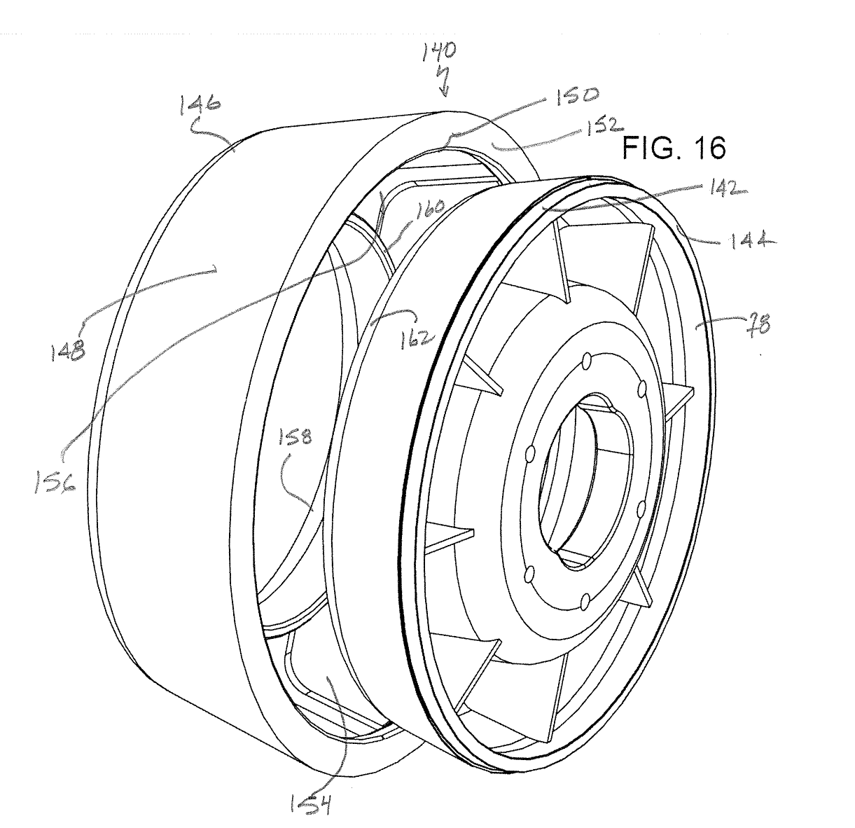

Referring now to FIGS. 12-15, an alternate embodiment to the linkage 30 is generally designated 110. Components shared with the linkage 30 are designated with identical reference numbers. In the linkage 110, the first or upper arms 38 are relatively the same as in the linkage 30 as seen in FIG. 11, including the slots 94 having notches 100, and accommodating the spring rod 92.

A second arm 112 has vertically projecting stops 46, but also includes a distinct spring rod adjustment system. Each second arm 112 has a plurality of spaced spring rod apertures 114 constructed and arranged for accommodating the lower spring rod 92 in a variety of positions, from proximate to distal relative to the base portion 20. While the rod apertures 114 are shown defining a somewhat arcuate pattern, other patterns, including straight linear, are contemplated.

The spring rod 92 is held in a tensioner arm assembly, generally designated 116, including a pair of main bars 118, held in spaced, parallel arrangement by the spring rod and by a handle 120. In the preferred embodiment, the handle 120 is located in proximity to a free end 122 of the bars 118, which is opposite a pivot end 124 of the bars. A pivot pin 126 projects laterally outwardly from each bar 118 and engages a corresponding pivot bore 128 in each arm 112. Thus, the tensioner assembly 116 pivots relative to the arms 112 under the control of the handle 120.

Referring now to FIGS. 12-14, to retain the spring rod 92 in a designated position relative to the first or upper arm 38, one end 130 of the spring rod projects past the corresponding bar 118. The tensioner assembly 116 is constructed so that the bars 118 are spaced laterally narrower than a spacing of the arms 112 so that there is lateral play or movement of the assembly relative to the arms.

During operation, with the spring 90 attached to both spring rods 92, the position of the lower spring rod 92 is changed by the user grasping the handle 120 and moving the assembly 116 laterally relative to the arms 112 so that the spring bar end 130 is disengaged from the corresponding spring rod aperture 114. The user then moves the handle 120 so that the assembly 116 pivots relative to the arms 112 about the pins 126 until the spring bar end 130 is aligned with a desired spring rod aperture 114. Next, the user shifts that assembly 116 laterally so that the spring bar end 130 engages the new aperture 114. Tension generated by the spring 90 keeps the spring bar end 130 from becoming disengaged from the associated spring rod aperture 114. Thus, by moving the position of the spring rod 92 in the second arms 112 relative to the spring rod 92 in the first arm 38, the relative upforce or downforce of the linkage 110, and the assembly 14 is achieved. It will be understood that embodiments equipped with the spring 90, spring rods 92 and related tensioning assembly, will not be fitted with the fluid power cylinder 88.

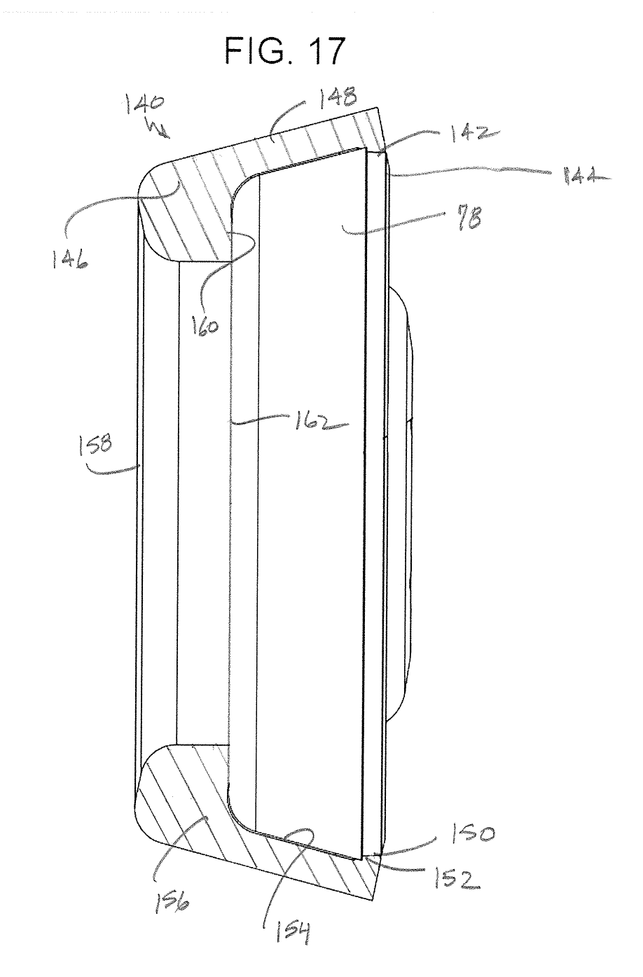

Referring now to FIGS. 16 and 17, a modified version of the depth band 78 is generally designated 140. The standard depth band is shown at 78. In some cases, additional surface area is desired, to prevent the disks 52, 54 from sinking excessively into the soil, depending on the soil conditions. A modification is made by creating, as by machining or the like, an annular groove 142 in a large diameter end 144 of the band 78. When the depth band 78 is attached to the disks, 52, 54, the larger diameter end 144 is closest to the disk.

To increase the surface area of the band 78, a depth band expander 146 is provided. The expander 146 is generally bowl-shaped, and surrounds the existing band 78. An annular wall 148 of the expander 146 is inclined in similar fashion to the band 78, but has a greater surface area for contacting the soil. An open end 150 of the expander 146 includes a generally radially inwardly projecting annular lip 152 defining a smaller diameter than the groove 142 and that thus engages the groove in a snap-fit orientation. In the preferred embodiment, the expander 146 is made of plastic material, and as such is somewhat flexible.

An internal chamber 154 of the expander 146 accommodates the band 78 (FIG. 17), and suitable support ribs 156 or other structures are provided for supporting the band 78 within the chamber 154. Opposite the open end 150 is a hub cap end 158 providing access to the hub cap 82 as described above, and including a band support ring 160 configured for engaging a distal end 162 of the band 78. A user installs the expander 146 by pushing it over the band 78 until the lip 152 snaps into the groove 142.

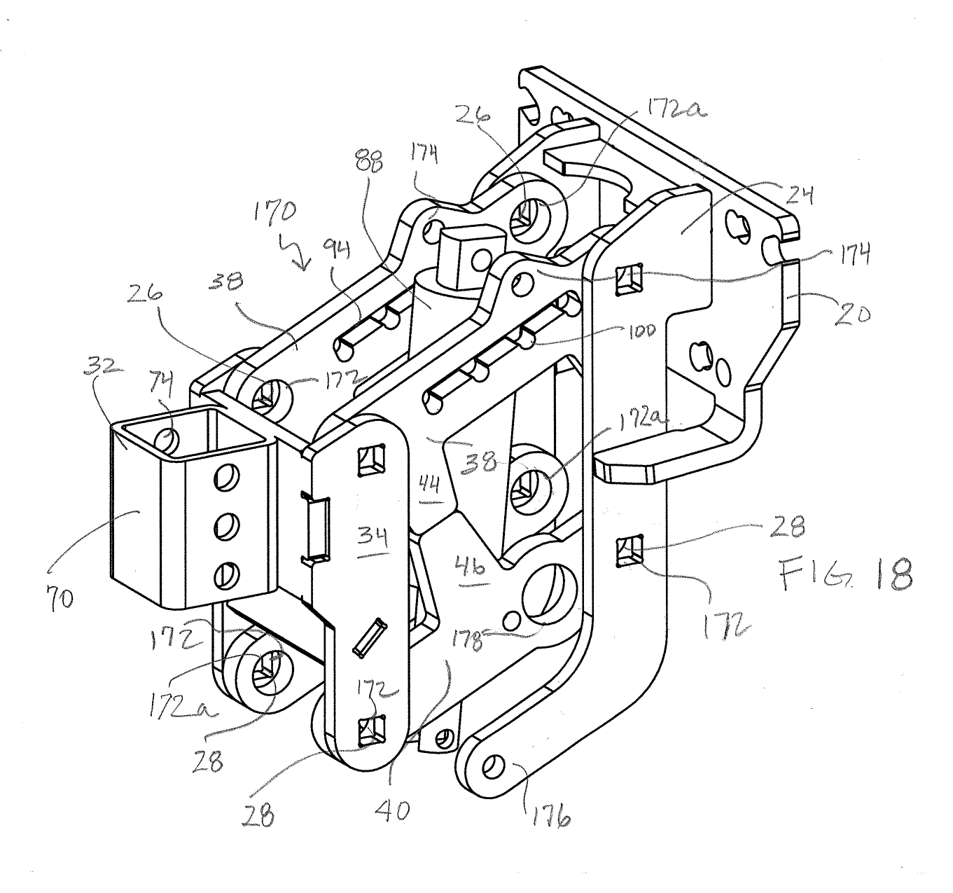

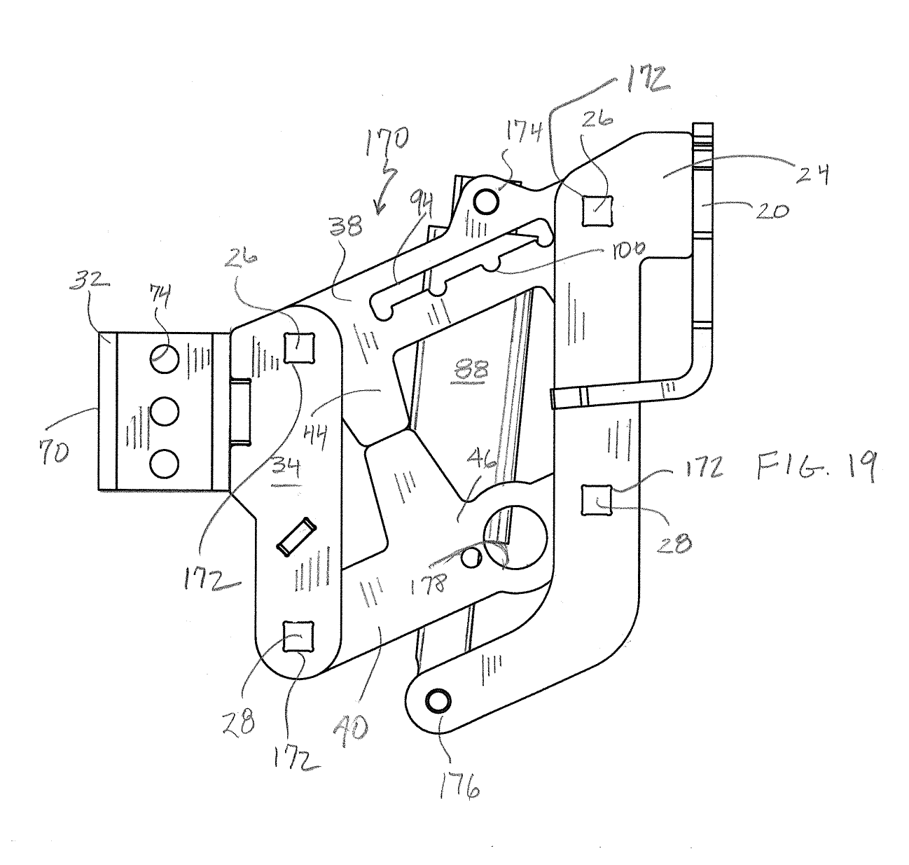

Referring now to FIGS. 18 and 19, an alternate embodiment of the linkage 30 and 110 is generally designated 170. Components shared with the linkages 30 and 110 are designated with identical reference numbers. One distinctive feature of the linkage 170 is that there is only a single first arm 38 and a single second arm 40 associated with each of the pivot points 26, 28 on the base portion 20 and the mounting bracket 32. In addition, at each of the pivot points 26, 28 on the base portion 20 and the mounting bracket 32 a flange aperture 172 has a rectangular, square or other non-circular shape. This construction facilitates the use of a carriage bolt 42 (not shown, see FIGS. 5 and 6) to mount the respective arms, and a bushing (not shown) is placed in arm apertures 172a. In operation, this assembly provides a more convenient way to change the bushings and/or first and second arms 38, 40 when needed.

Another distinguishing feature of the linkage 170 is that the fluid power cylinder 88 is mountable to eyelets 174 on the first arms 38 instead of on the flanges 24. At the opposite end, the cylinder 88 is mountable to a lower end 176 of the flange 24. In the preferred embodiment, the fluid power cylinder 88, which can be either pneumatic or hydraulic, is mountable in a rod-up or rod down orientation. This modified cylinder mount enables the cylinder 88 to be mounted at an oblique or non-vertical angle relative to the ground surface 18. Such an arrangement accommodates a wide range of cylinder types and configurations. Also, instead of the stepped lower slot 96, the linkage 170 includes a spring tensioner mounting aperture 178 in the lower arm 40. The aperture 178 receives a spring tensioner similar to the components 116, 118 described above. While in FIGS. 18 and 19, the arms 38 and 40 depict the slots 94 and the mounting aperture 178 used with a spring tensioning arrangement as discussed above in relation to FIGS. 11-15, it is preferred that the fluid power cylinder 88 provide the biasing force instead of the spring 90.

Referring again to FIGS. 1-3, regardless of the linkage embodiment 30, 110 or 170, an advantage of the present debris clearing apparatus 12 is that the unit is independently movable relative to the planter row unit 10. As is known in the art, the planter row unit 10 is preferably provided with a planter linkage 180 including upper and lower arms 182, 184 designed to facilitate the movement of the planter row unit over uneven ground. The arms 182, 184 are pivotably connected to a tow bar mount 186 at one end, and a planter unit mount 188 at an opposite end. However, in practice, when conventional debris clearing units are mounted to such row units, due to the distance of the clearing disk assembly from the planter linkage, the debris clearing unit often encounters the particular dip or rise in the ground before the planter row unit 10. As such, there is a delay in the reaction of the planter linkage 180 relative to the debris clearing unit. This relatively slow reaction by the conventional debris clearing units has caused unwanted gouging of the soil.

The present debris clearing apparatus 12 addresses this problem by providing an independent linkage 30, 110, 170 that maintains the disk assembly 14 parallel to the ground in that the stem 68 and/or the mounting bracket 32 remains relatively vertical relative to the ground contour 18. This is achieved by providing the linkage 30, 110, 170 which moves along the ground contour 18 ahead of and independently from the pivoting planter linkage 180. Described another way, relating to the disk assembly 14, the forward and rearward disks, 52, 54 are maintained generally horizontal relative to each other such that a centerline of each axle forms a horizontal line.

While a particular embodiment of the present floating debris clearing apparatus having parallel support linkage has been described herein, it will be appreciated by those skilled in the art that changes and modifications may be made thereto without departing from the present disclosure in its broader aspects.

What is claimed:

1. A debris clearing apparatus being mounted to and pushed by a planter row unit for agricultural operations, comprising:
a base portion configured for attachment to the row unit;
a disk assembly including at least one rotating trash clearing device and a mounting bracket; and
said at least one trash clearing device connected to said base portion for vertical reciprocal movement by a parallelogram linkage including at least one first arm and at least one second arm, each of said first and second arms being pivotably connected at corresponding ends to said bracket and to said base portion.

2. The apparatus of claim 1, wherein said base portion includes a pair of laterally separated flanges, and said mounting bracket has first and second sides, said at least one first arm is connected between each of said flanges and a corresponding one of said first and second sides, and said at least one second arm is connected between each of said flanges and a corresponding one of said first and second sides.

3. The apparatus of claim 2, wherein said at least one first arm is connected to said mounting bracket at a location spaced vertically from a connection of said at least one second arm to said mounting bracket.

4. The apparatus of claim 2, further including a pair of first arms on each said side of said mounting bracket, and a pair of second arms on each said side of said mounting bracket.

5. The apparatus of claim 1, further including at least one biasing element connected to said parallel linkage for exerting at least one of a downward and an upward biasing force on said trash clearing device as it moves through the ground.

6. The apparatus of claim 5, wherein said at least one biasing element is at least one of a fluid power cylinder and a spring.

7. The apparatus of claim 1, wherein said trash clearing device includes a pair of clearing disks, one disposed in linearly displaced position relative to the other in the direction of travel of the apparatus.

8. The apparatus of claim 7, wherein at least one of said clearing disks has a generally laterally extending annular depth band for controlling the depth the clearing disks sinks into the ground during operation.

9. The apparatus of claim 7, wherein at least one of said clearing disks has a hub cap lockable to a depth band through rotation of the hub cap about an axis.

10. The apparatus of claim 9, wherein said hub cap is generally centrally located relative to said depth band.

11. The apparatus of claim 8 further including a depth band expander configured for engagement over said depth band for increasing surface area of the band that contacts the soil.

12. The apparatus of claim 1, wherein mechanical stops on at least one of said upper arms and said lower arms limit the degree of vertical movement of said linkage.

13. The apparatus of claim 12, wherein said stops include a depending formation on said at least one first arm, and a vertically extending formation on said at least one second arm.

14. The apparatus of claim 1, wherein said linkage further includes upper and lower transverse spring rods mounted in for relative, generally horizontal movement in both the upper and lower link arms, at least a pair of the upper and lower arms has a forwardmost and rearwardmost rod position;
said rods in the upper link arms are adjustable relative to the rods in the lower link arms; and
springs connected between said rods exert a biasing force on the linkage that forces the linkage into the soil.

15. The apparatus of claim 14, configured so that by moving the rods in the upper and lower arms relative to each other, the spring tension is adjustable, when the spring is generally vertical relative to the arms, there is a neutral biasing force applied; and when the rods are at their full distance displacement from each other, the springs exert their full biasing force.

16. The apparatus of claim 14, wherein said rods and said spring are constructed and arranged in said slots so that when said rods are in a first position, an upward biasing force is exerted on the linkage, and when said rods are in a second position, a downward biasing force is exerted on the linkage.

17. The apparatus of claim 14, wherein said lower link arms are provided with a tensioner arm assembly that pivots relative to said lower link arms under the control of a handle for adjusting a position of the associated spring rod relative to the lower link arms.

18. The apparatus of claim 17, wherein said tensioner arm assembly is laterally movable relative to said lower link arms for selectively disengaging an end of the spring rod from an associated aperture in said tensioner arm.

19. A debris clearing apparatus mounted to and pushed by a planter row unit for agricultural operations, the planter row unit having a pivoting planter linkage, said debris clearing apparatus comprising:
a base portion configured for attachment to the row unit;
a disk assembly including at least one rotating trash clearing device and a mounting bracket; and
said at least one trash clearing device connected to said base portion for vertical reciprocal movement by a parallelogram linkage including at least one first arm and at least one second arm, each of said first and second arms being pivotably connected at corresponding ends to said bracket and to said base portion so that said apparatus moves relative to the ground independently from the planter linkage.

20. The apparatus of claim 19 wherein said disk assembly includes forward and rearward trash clearing disks, and said independent operation of said apparatus maintains said forward and rearward disks generally horizontal relative to each other as said apparatus moves relative to the ground.
